(19) United States
(12) Patent Application Publication
(10) Pub. No.: US 2010/0245028 A1
(43) Pub. Date: Sep. 30, 2010

(54) CIRCUIT PROTECTIVE DEVICE AND METHOD FOR MANUFACTURING THE SAME

(76) Inventors: Tomoyuki Washizaki, Fukui (JP); Toshiyuki Iwao, Fukui (JP); Takashi Kitamura, Fukui (JP); Takashi Watanabe, Fukui (JP); Naohiro Mikamoto, Fukui (JP); Masahito Fuchigami, Fukui (JP); Kazutoshi Matsumura, Fukui (JP)

Correspondence Address: WENDEROTH, LIND & PONACK L.L.P., 1030 15th Street, N.W., Suite 400 East, Washington, DC, 20005-1503, US

(21) Appl. No.: 12/739,980

(22) PCT Filed: Nov. 6, 2008
(86) PCT No.: PCT/JP2008/003203

§ 371 Date: Apr. 27, 2010

(30) Foreign Application Priority Data
Nov. 8, 2007 (JP) 2007-290314
Jan. 18, 2008 (JP) 2008-008870
Mar. 26, 2008 (JP) 2008-079619
Aug. 26, 2008 (JP) 2008-216130

(51) Int. Cl. H01H 85/04; H01H 69/02

(52) U.S. Cl. 337/297; 29/623

(57) ABSTRACT

A circuit protecting element includes insulating substrate (11), a pair of surface electrodes (12) provided to both ends of a top face of insulating substrate (11), element (13) bridging the pair of surface electrodes (12) and electrically connected to the pair of surface electrodes (12), base layer (14) formed between element (13) and insulating substrate (11), and insulating layer (15) covering element (13). Base layer (14) is formed of a mixture of diatom earth and silicone resin. The structure discussed above allows stabilizing the blowout characteristics of the circuit protecting element.

### TECHNICAL FIELD

The present invention relates to a circuit protecting element which is used in a variety of electronic devices and blown out by an over-current for protecting the devices.

### BACKGROUND ART

FIG. 9 shows a conventional circuit protecting element (disclosed in Patent Document 1) comprising the following structural elements:
insulating substrate 1;
a pair of surface electrodes 2 provided to both ends of the top face of substrate 1;
base layer 3 made of epoxy resin formed on the top face of substrate 1;
element 4 electrically connected to the pair of surface electrodes 2 on the top face of base layer 3;
insulating layer 5 covering element 4; and
a pair of shoulder electrode layers 6 formed on both ends of substrate 1.

Base layer 3 of the foregoing conventional circuit protecting element; however, is made of epoxy resin having a low heat resistance, so that its shape becomes unstable due to the heat produced by a laser beam with which trimming grooves are formed on element 4. This unstable shape of base layer 3 sometimes causes the shape of element 4 to be unstable, which invites dispersion in the blowout characteristics of the circuit protecting element.

Patent Document 1: Unexamined Japanese Patent Application Publication No. H05-225892

### DISCLOSURE OF INVENTION

The present invention addresses the problem discussed above, and aims to provide a circuit protecting element of which blowout characteristics are stable. The circuit protecting element of the present invention comprises the following structural elements:
an insulating substrate;
a pair of surface electrodes provided to both ends of the top face of the insulating substrate;
a base layer formed on the top face of the substrate such that the base layer is connected to the pair of surface electrodes;
an element covering the base layer, bridging the pair of surface electrodes, and also electrically connected to the pair of surface electrodes; and
an insulating layer covering the element,

wherein the base layer is formed of a mixture of diatom earth and silicone resin.

Since the diatom earth and the silicone resin forming the base layer are excellent in the heat resistance, the base layer can be prevented its shape from being unstable caused by the heat produced by a laser beam with which the trimming grooves are formed on the element. As a result, the element becomes stable in its shape, so that the blowout characteristics can be stabilized.

### BRIEF DESCRIPTION OF THE DRAWINGS

FIG. 1 shows a sectional view of a circuit protecting element in accordance with an embodiment of the present invention.

FIG. 2 shows a top view of an essential part of the circuit protecting element in accordance with the embodiment of the present invention.

FIG. 3A shows a top view illustrating a part of a manufacturing method of the circuit protecting element in accordance with an embodiment of the present invention.

FIG. 3B shows a top view illustrating a part of a manufacturing method of the circuit protecting element in accordance with an embodiment of the present invention.

FIG. 4A shows a top view illustrating a part of a manufacturing method of the circuit protecting element in accordance an embodiment of the present invention.

FIG. 4B shows a top view illustrating a part of a manufacturing method of the circuit protecting element in accordance with an embodiment of the present invention.

FIG. 5 shows a top view of another circuit protecting element partially cutout in accordance with an embodiment of the present invention.

FIG. 6 shows a sectional view cut along line 6-6 in FIG. 5.

FIG. 7A shows a top view illustrating a part of a manufacturing method of a circuit protecting element partially cut in accordance with an embodiment of the present invention.

FIG. 7B shows a top view illustrating a part of a manufacturing method of a circuit protecting element partially cut in accordance with an embodiment of the present invention.

FIG. 8A shows a top view illustrating a part of a manufacturing method of a circuit protecting element partially cut in accordance with an embodiment of the present invention.

FIG. 8B shows a top view illustrating a part of a manufacturing method of a circuit protecting element partially cut in accordance with an embodiment of the present invention.

FIG. 9 shows a sectional view of a conventional circuit protecting element.

### DESCRIPTION OF REFERENCE MARKS

11 insulating substrate
12 surface electrode
13 element
13a first element
13b second element
14 base layer
15 insulating layer
15a first insulating layer
15b second insulating layer
16 shoulder electrode layer
17 trimming groove
18 blowout section
21 sheet-like insulating substrate
22a, 22b dividing groove
23 dummy electrode
23a lateral dummy section
23b vertical dummy section
24 section
25a, 25b trimming groove for forming a blown-out section
26a, 26b, 26c, 26d, 26e, 26f trimming groove for adjusting a resistance value
27 open-cut groove

### Preferred Embodiment of Invention

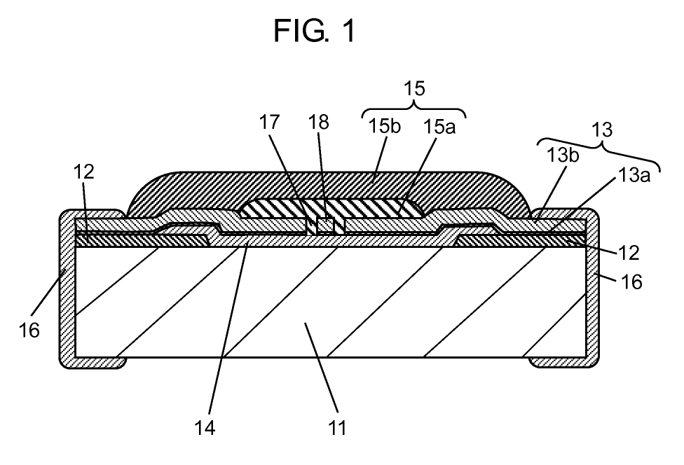

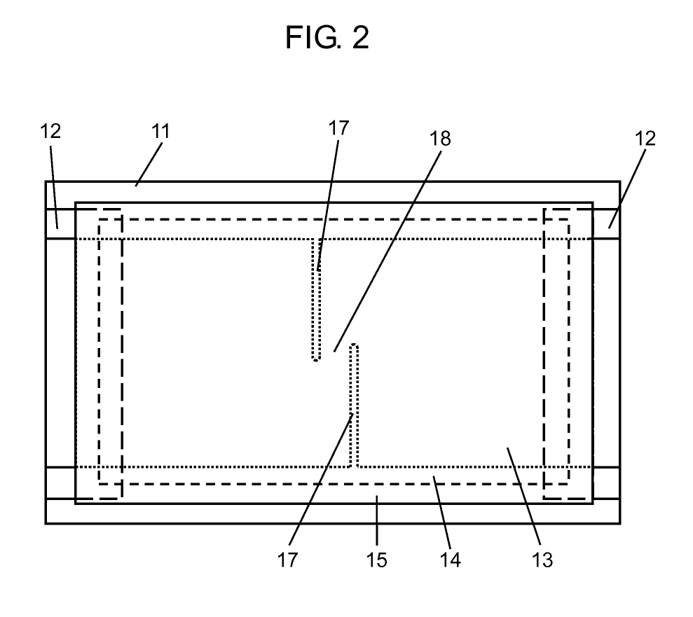

An exemplary embodiment of the present invention is demonstrated hereinafter with reference to the accompanying drawings. FIG. 1 shows a sectional view of a circuit protecting element in accordance with the embodiment of the present invention. FIG. 2 shows a top view of an essential part of the circuit protecting element.

As shown in FIGS. 1 and 2, the circuit protecting element in accordance with this embodiment comprises the following structural elements:
insulating substrate 11;
a pair of surface electrodes 12 provided to both ends of the top face of insulating substrate 11;
base layer 14 made of a mixture of diatom earth and silicone resin and formed on the top face of substrate 11 such that base layer 14 is connected to the pair of surface electrodes 12;
element 13 covering base layer 14, bridging the pair of surface electrodes 12, and also electrically connected to the pair of surface electrodes 12, and formed of first element 13a (thin film layer) and second element 13b (plated layer); and
insulating layer 15 covering element 13.
   Element 13 includes trimming grooves 17, so that element 13 shapes like meanders.

To be more specific about the foregoing structure, insulating substrate 11 shapes like a square, and contains Al₂O₃ in the range of 55-96%. The pair of surface electrodes 12 is provided to both the ends of the top face of substrate 11, and formed by printing Ag on the top face. Element 13 is provided on the top faces of surface electrodes 12 and base layer 14 such that element 13 can cover the entire surface of substrate 11.

First element 13a is formed by sputtering Ti, Cu or Cr, CuNi in this order, and second element 13b is formed by electrolytic plating or electroless plating Ni, Cu, Ag in this order onto first element 13a that works as a base for the plating.

At the center of element 13, trimming groove 17 is formed with a laser beam at two places, i.e. from the upper side of element 13 toward the center, and from the lower side toward the center, namely, the grooves are formed along the vertical direction in FIG. 2 toward the center. The region surrounded by these two grooves forms blowout section 18 which is supposed to blow out and break when an over current flows. Blowout section 18 thus formed has a higher density of electric current, so that element 13 confined within blowout section 18 can be blown out earlier. The circuit protecting element excellent in responsiveness thus can be produced, and another formation of trimming groove 17 allows adjusting a resistance value.

As shown in FIG. 2, element 13 is formed such that its lateral wall (a side of element 13 along vertical direction in FIG. 2) will not bulge out of base layer 14. This structure allows preventing element 13 from touching insulating substrate 11, so that the diffusion of the heat of substrate 13 into substrate 11 can be reduced. As a result, the circuit protecting element excellent in responsiveness can be produced.

Blowout section 18 can be covered with the metal, such as Sn, Zn, or Al, having a melting point lower than that of element 13. This preparation allows melting the metal having the lower melting point faster than other parts, so that element 13 confined within blowout section 18 can be blown out faster. As a result, the circuit protecting element excellent in responsiveness can be obtained.

Base layer 14 is placed in the center of insulating substrate 11, and formed on almost entire top face of substrate 11 such that both the ends of layer 14 can overlap with the top face of the pair of surface electrodes 12. In this case, at least parts of surface electrodes 12 are exposed. Base layer 14 does not necessarily overlap with the top face of surface electrode 12; however, the caution is preferably paid to element 13 so as not to touch substrate 11. In other words, base element 14 is placed between substrate 11 and element 13 that is located between the pair of surface electrodes 12.

On top of that, base layer 14 is formed of the mixture of diatom earth and silicone resin, and the heat conductivities of these materials are not greater than 0.2 W/m·K, so that the diffusion of the heat from element 13 into substrate 11 can be reduced. As a result, the circuit protecting element excellent in responsiveness can be obtained. Base layer 14 contains diatom earth at a mixed ratio in the range of 50-90 volumetric %, and the more preferable range is 55-70 volumetric %.

The diatom earth is used as one of the materials for wall plate or heat-proof brick, so that it is fire-proof and light-weight soil having an ultra-porous and hyperfine structure. Since the diatom earth is fire-proof, the blowout characteristics can be kept stable although element 13 becomes hot due to an over-current. Since element 13 becomes hot due to the over-current, the resin to be mixed with the diatom earth should be fire-proof. The silicone resin is best suited for this purpose, and epoxy resin and others do not suit to this application because they are inferior to the silicone resin in fire resistance. Both of the diatom earth and the silicone resin are available in ample volume at a low cost, so that the productivity can be improved.

On top of that, the silicone resin forming base layer 14 is colored by mixing a pigment of blue or red except white in approx. 1 wt % with the silicone resin. The insulating substrate including alumina looks, in general, white, so that if element 13 encounters a defective such as a print blur or a fracture, the defective cannot be recognized on the white-look substrate. However, since this embodiment colors the silicone resin as discussed above, the defective can be recognized and then screened with ease by human eyes or an automatic inspection.

Base layer 14 can be formed not only in the center but also on almost all the top face of substrate 11, and then the pair of surface electrodes 12 can be formed on both ends of base layer 14.

Base layer 14 can be formed by mixing silicone resin with alumina powder. In this case, since the silicone resin has the heat conductivity not greater than 0.2 W/m·K, so that the diffusion of the heat from element 13 into substrate 11 can be reduced. As a result, the circuit protecting element excellent in responsiveness can be obtained. Base layer 14 contains the alumina powder at a mixed ratio in the range of 50-80 volumetric %, and the heated alumina powder can tightly bond to alumina or silica contained in substrate 11. On top of that, the silicone resin can strongly adhere to the alumina of substrate 11. Base layer 14 thus adheres to substrate 11 more strongly.

If base layer 14 contains the alumina powder at a mixed ratio over 80 volumetric %, its heat conductivity increases due to the greater amount of the alumina powder, so that element 13 resists increasing its temperature even if an over current flows. As a result, the blowout characteristics of element 13 are degraded, and thixotropy of base element 14 is also degraded, which are not favorable for handling the circuit protecting element. On the other hand, if base layer 14 contains the alumina powder at a mixed ratio less than 50 volumetric %, the content ratio of the resin increases in base layer 14, so that base layer 14 tends to move its location due to the heat or stress when first element 13a is formed by the sputtering. First element 13a is thus subjected to cracks, so that the mixed ratio of the alumina powder at less than 50 volumetric % is not favorable.

The alumina powder to be mixed with silicone resin can be replaced with silica powder, or both of alumina powder and silica powder can be mixed with the silicone resin for forming base layer 14.

Insulating layer 15 covers element 13 and is formed of first insulating layer 15a made of resin such as silicone resin for covering blowout section 18 and second insulating layer 15b made of resin such as epoxy resin and placed on first insulating layer 15a.

Insulating layer 15 in parts (lateral section of layer 15) bulges out of base layer 14 as shown in FIG. 2. In other words, element 13 and base layer 14 are formed in the center of and under insulating layer 15, while no element 13 or no base layer 14 is formed under the lateral section of insulating layer 15. This structure allows insulating layer 15 in parts to directly touch insulating substrate 11, so that layer 15 can adhere to layer 14 more strongly.

Shoulder electrode layer 16 made of silver-based material is formed on both the ends of insulating substrate 11 such that shoulder electrode layer 16 overlaps with element 13 in parts. Electrode layer 16 is coated with a plated film (not shown) on its surface.

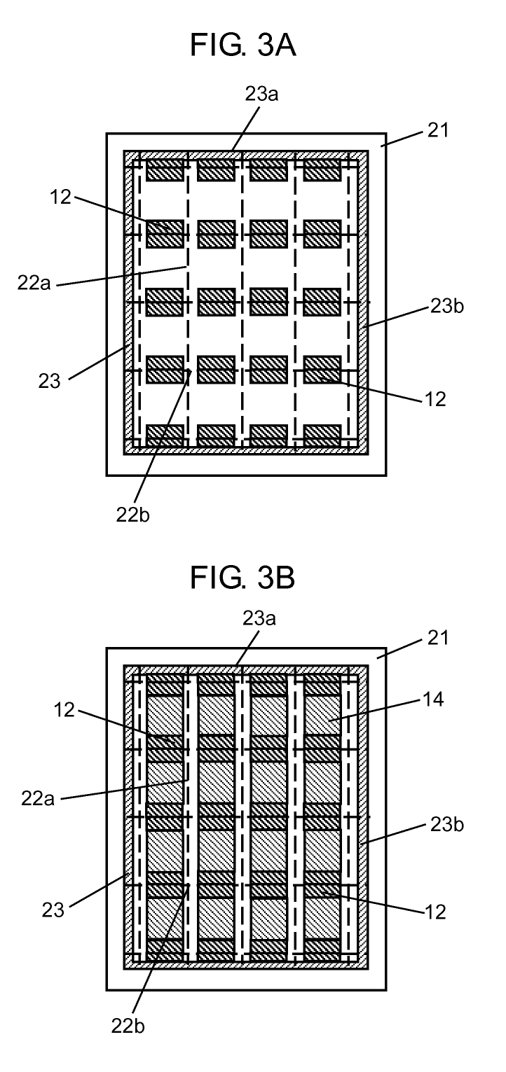

A method of manufacturing the circuit protecting element in accordance with the embodiment is demonstrated hereinafter. In FIG. 3A, firstly, prepare sheet-like and square insulating substrate 21 made of alumina containing Al₂O₃ in the range of 55-96%. Insulating substrate 21 includes, on its top face, multiple dividing grooves 22a formed in a vertical direction and dividing grooves 22b formed in a horizontal direction. Each one of the sections surrounded by grooves 22a and 22b is a chip-like circuit protecting element. FIG. 3A shows five grooves 22a and five grooves 22b for the description purpose; however the present invention is not limited to this structure, and other numbers of grooves can be used.

Next, print the conductive paste of palladium silver alloy, of which main ingredient is silver paste or silver, such that the paste strides across lateral dividing grooves 22b. The paste is then fired for forming multiple surface electrodes 12. A pair of surface electrodes 12 is thus formed on both the ends of the top face of insulating substrate 11 in the chip-like circuit protecting element.

Form dummy electrode 23 shaping like a square frame which surrounds the region where surface electrodes 12 are formed. Dummy electrode 23 is made of the same material as surface electrode 12 and formed by printing at the same time as surface electrode 12 is printed. Dummy electrode 23 is formed of a pair of lateral dummies 23a and a pair of vertical dummies 23b. The pair of lateral dummies 23a is connected to multiple surface electrodes 12. Dummy electrode 23 can be formed before or after the formation of surface electrodes 12.

Next, as shown in FIG. 3B, print the paste on the top face of insulating substrate 11 such that the paste can connect to surface electrode 12. This paste is a mixture of organic solvent, diatom earth, and silicone resin. The diatom earth is mixed in the range of 50-90 volumetric %. Then the paste is heated at 150-200° C. to be hardened for vaporizing the organic solvent. Base layer 14 is thus formed, and at least parts of surface electrodes 12 are to be exposed.

The mixture of diatom earth in base layer 14 in the range of 50-90 volumetric % allows decreasing the difference in heat shrinkage rates between base layer 14 and first element 13a (thin film layer) formed by the sputtering. As a result, first element 13a can be free from cracks produced by the heat during the sputtering, so that the locations of element 13 and base layer 14 can be stabilized, which allows stabilizing the location of trimming grooves 17.

The silicone resin colored in blue allows recognizing and screening a defective on element 13 with ease by human eyes or an automatic inspection machine.

On top of that, a rear electrode (not shown) can be formed by printing and firing the paste made of palladium silver alloy, of which major ingredient is silver paste or silver, in order to stabilize the circuit protecting element when the element is mounted to a device.

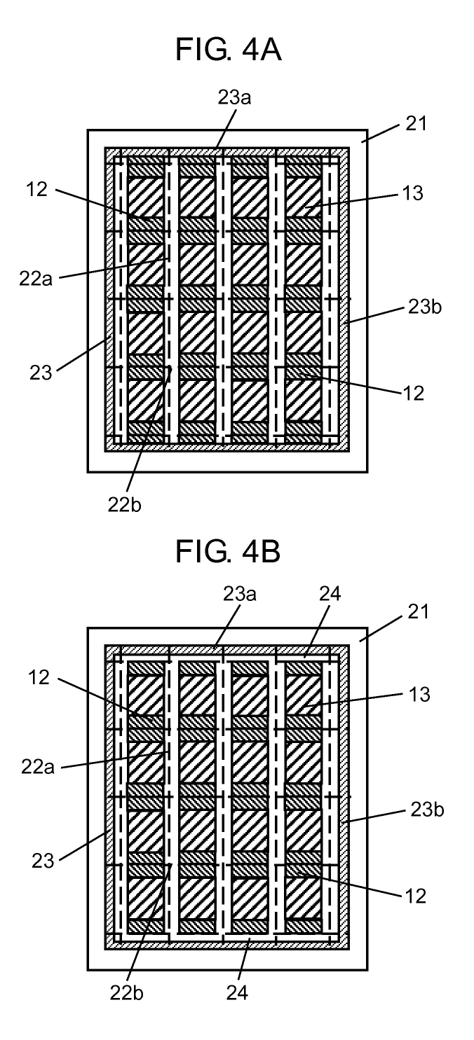

Then form element 13 on the top faces of base layer 14 and the pair of surface electrodes 12 as shown in FIG. 4A. Element 13 bridges the pair of electrodes 12 so that it can electrically connect thereto. Element 13 is formed of first element 13a and second element 13b. In FIG. 1, sputter Ti, Cu or Cr, CuNi in this order onto base layer 14 and onto surface electrodes 12, so that first element 13a is provided so as not to override the width of base layer 14. Second element 13b is formed by electrolytic plating or electroless plating Ni, Cu, Ag in this order onto first element 13a working as a base for the plating. Element 13 is thus formed.

When first element 13a is formed, the sputtering is carried out while sheet-like insulating substrate 21 is heated from the base layer side because the heat is accumulated in base layer 14, which can be thus kept hot so that first element 13a can be formed quickly. When second element 13b is formed by the electrolytic plating, one of dummy electrodes 23 is connected to a power feeder section. This preparation allows forming second element 13b with ease. Use of the electroless plating method allows forming second elements 13b simultaneously on numbers of chip-like circuit protecting circuits.

Next, as shown in FIG. 4B, sections 24 between multiple surface electrodes 12 and the pair of lateral dummies 23a are cut so that dummies 23a are brought to out of conduction with surface electrodes 12. Then measure a resistance value between a pair of surface electrodes 12, and form trimming grooves 17 on element 13. When the resistance value is measured, this preparation allows prohibiting the electric current from flowing on the surface electrodes 12 except the pair of surface electrodes 12 of which resistance value is measured, so that the resistance value can be reliably measured. In this case, irradiate element 13 with a laser beam, thereby cutting element 13 for forming trimming groove 17 at two places along the direction from the lateral face toward the center of elements 13 confronting one another. A region surrounded with these two trimming grooves 17 forms blowout section 18 which is supposed to blow out when an over current flows through this region.

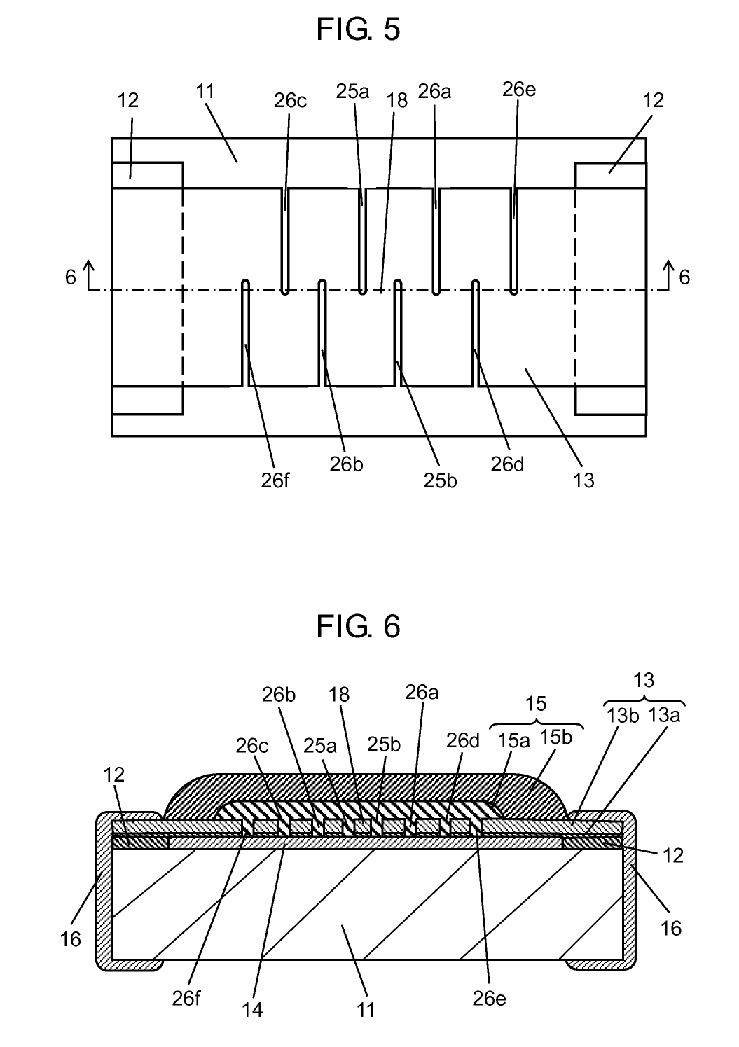

In this case, as shown in FIGS. 5 and 6, trimming grooves 17 includes grooves 25a, 25b which can be formed on element 13 for forming the blowout section, and grooves 26a-26f which can be formed on element 13 for adjusting a resistance value.

A method of forming trimming grooves 17 is demonstrated hereinafter, i.e. forming grooves 25a, 25b for the blowout section and grooves 26a-26f for the adjustment of resistance value. First, measure a resistance value of element 13 located between a pair of surface electrodes 12. When this resistance value falls within a given range, irradiate element 13 with a laser beam at two places in the center, thereby cutting element 13 for forming a pair of trimming grooves 25a, 25b (first and second trimming grooves) along the direction from the lateral face toward the center of elements 13 confronting one another. The region surrounded with the first and the second trimming grooves 25a, 25b form blowout section 18 which is supposed to blow itself out and cut off the current when an over current flows. These first and second grooves 25a and 25b are formed such that they overlap each other. The product of the length of the overlapped sections by the space between the overlapped sections of grooves 25a and 25b, i.e. the area (volume) of blowout section 18 will determine the blowout characteristics. Considering this fact, first and second trimming grooves 25a and 25b are preferably formed in advance, thereby reducing the possibility of dispersion in the blowout characteristics. First-sixth grooves 26a-26f for adjusting resistance value can be formed thereafter, and then the resistance value can be adjusted.

As discussed above, the resistance value of element 13 is firstly measured, and only when the resistance value falls within the given range, trimming grooves 25a, 25b are formed. The reason of this procedure is this: The area of blowout section 18 depends on the blowout characteristics and the rated current required by the specification, and the area will automatically determine the locations of first and second grooves 25a and 25b. The resistance value of element 13 after the formation of grooves 25a, 25b is also determined automatically. In other words, the formation of grooves 25a and 25b should not be carried out while the resistance value is adjusted.

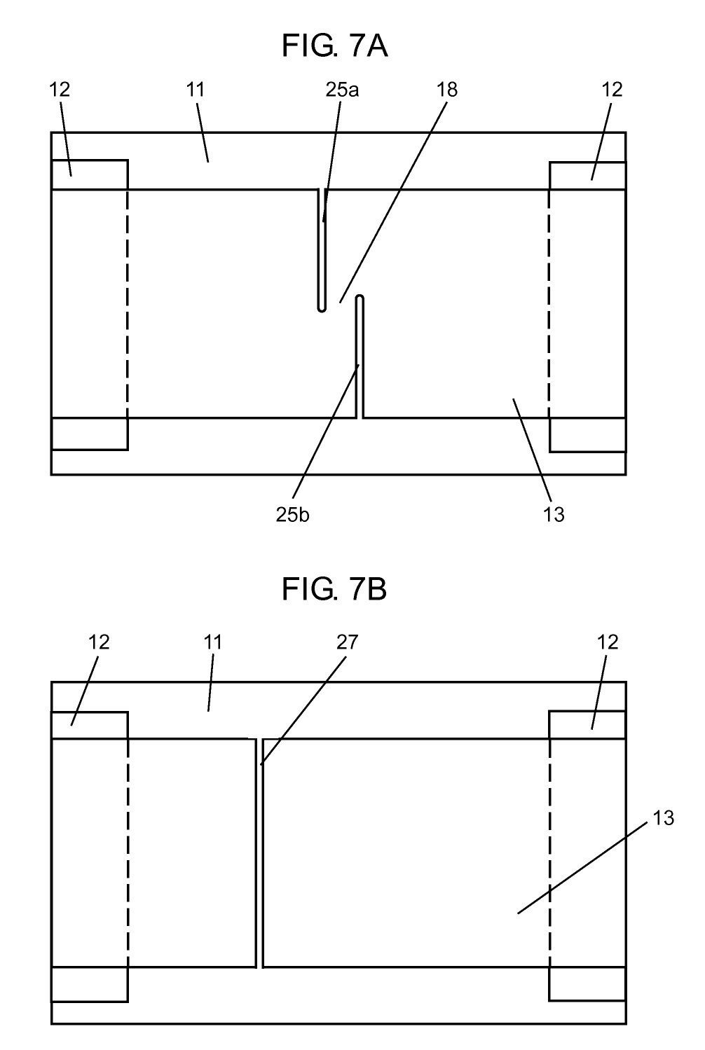

When an initial resistance value of element 13 falls outside the given range, trimming grooves 25a, 25b cannot be formed at given locations, because the blowout characteristics and the rated current required by the specification cannot be satisfied. In this case, as shown in FIG. 7B, form open-cut groove 27 by making a cut on element 13 generally with respect to the width direction of element 13, so that element 13 becomes open. If this element 13 without grooves 25a, 25b due to its resistance value falling outside the given value has a resistance value close to that of a finished product, the work of making a cut allows preventing this element 13 from being judged as a non-defective product although the blowout section is not formed.

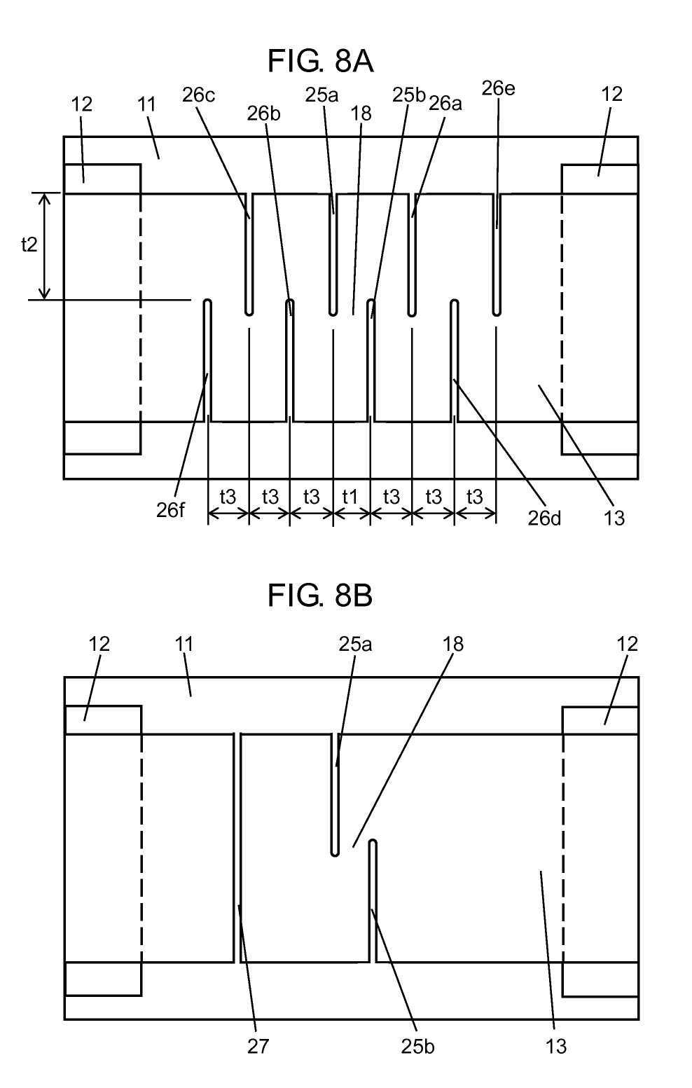

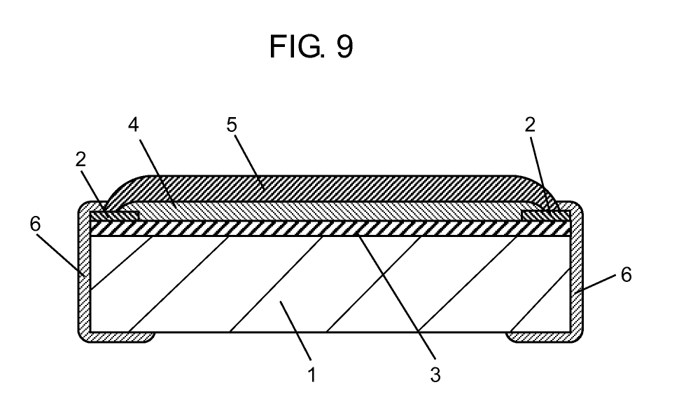

Next, measure the resistance value of element 13 after the formation of grooves 25a and 25b. Only when the resistance value falls within the given range, irradiate elements 13 on both sides of grooves 25a and 25b with a laser beam, thereby cutting these elements along the direction from the lateral face toward the center of elements 13 confronting each other as shown in FIG. 8A. Then form first-sixth trimming grooves 26a-26f sequentially for adjusting resistance value. The formation of grooves 25a, 25b, and 26a-26f makes elements 13 in a meandrous pattern.

In this case, the first, third and fifth trimming grooves 26a, 26c, 26e for the adjustment of the resistance value are formed on the same side where first trimming groove 25a for the forming of the blowout section is formed. The second, fourth and sixth trimming groves 26b, 26d, 26f for the adjustment of the resistance value are formed on the same side where second trimming groove 25b for the blowout section is formed. To be more specific, on the left side of and closer to first groove 25a, the second, third and sixth grooves 26b, 26c, 26f are formed in this order. On the right side of and closer to second groove 25b, the first, fourth and fifth grooves 26a, 26d, 26e are formed in this order.

The resistance value of element 13 after the formation of trimming grooves 25a and 25b is measured, and only when the value falls within a given range, first-sixth trimming grooves 26a-26f are formed. The reason of this procedure is this: When the resistance value of element 13 is higher than the given range, the thickness of element 13 becomes thinner, so that the given blowout characteristics cannot be obtained, and it is necessary to exclude such element 13 having a thinner thickness and poor blowout characteristics. When the resistance value of element 13 after the formation of grooves 25a and 25b exceeds the range adjustable with trimming grooves 26a-26f, there is no need to form grooves 26a-26f.

When the resistance value of element 13 after the formation of grooves 25a and 25b falls outside the given range, open-cut groove 27 can be formed as shown in FIG. 8B.

Space “t1” between first trimming groove 25a and second trimming groove 25b is set smaller than length “t2” between each one of grooves 26a-26f and the lateral face confronting each one of grooves 26a-26f, of element 13. On top of that, grooves 26a-26f adjacent to each other are spaced away by space “t3”, and groove 25a is spaced away from groove 26b by space “t3”, and groove 25b is spaced away from groove 26a by also space “t3”, then the space “t1” is set equal to or smaller than space “t3”. The foregoing relation among t1, t2, and t3 allows blowout section 18 surrounded by grooves 25a and 25b to blow themselves out reliably.

In FIG. 8A, the tips of grooves 26a-26f are located such that they protrude toward the lateral face, confronting the respective tips, of element 13 from the center line (line 6-6 in FIG. 5) drawn across the shorter sides of element 13. However, it is not necessarily to follow this instance. The lengths of grooves 26a-26f are similar to one another in FIG. 8A; however, they can be different from one another.

After the formation of trimming grooves 17 (i.e. grooves 25a, 25b for forming the blowout section and grooves 26a-26f for adjusting resistance value), form first insulating layer 15a by using resin such as silicone resin for covering at least blowout section 18. Then form second insulating layer 15b by using, e.g. epoxy resin, on the top face of first insulating layer 15a, thereby forming dual-layered insulating layer 15.

Next, apply resin silver paste onto both the ends of insulating substrate 11 such that the paste overlaps with parts of element 13, and then harden the paste, thereby forming shoulder electrode layer 16, however, layer 16 can be formed through a thin-film process such as sputtering.

Finally, form a plated film (not shown) made of dual layers, i.e. one is a nickel layer and the other is a tin layer, on the top face of shoulder electrode layer 16. The circuit protecting element in accordance with this embodiment can be thus manufactured.

Before the formation of second element 13b, insulating substrate 11 (sheet-like insulating substrate 21) can be pasted with a stop-off sheet (not shown) on its rear face in order to prevent the rear face, in particular, electrodes on the rear face from being plated. This preparation allows preventing substrate 11 from being conductive on its rear face. In this case, the stop-off sheet can be pasted onto the rear face by using a temperature of the plating solution so that the stop-off sheet can more positively adhere onto the rear face without increasing the number of the manufacturing steps. To be more specific, when second element 13b is formed, dip it into the plating solution, which is heated to a temperature higher than the ordinary temperature (in both the cases of the electroless plating and the electrolytic plating), so that the stop-off sheet is also heated simultaneously. The stop-off sheet is increased its adhesiveness by the heating, so that the use of the higher temperature of the plating solution can eliminate an independent heating device, and yet, the adhesiveness of the stop-off can increase.

The stop-off sheet can be formed of pressure sensitive adhesive formed on a polyvinyl chloride film which works as a supporter. The stop-off sheet can preferably closely adhere to insulating substrate 11, and can be removed with ease.

In the foregoing embodiment, base layer 14 is formed of a mixture of diatom earth and silicone resin both of which are excellent in heat resisting characteristics. This structure allows preventing the heat due to the laser beam from making base layer 14 unstable in shape, so that element 13 can be stable in its shape, and thus the blowout characteristics can be stabilized.

The silicone resin can enter among the particles of the diatom earth, so that base layer 14 can be fixed strongly onto substrate 11, and atmospheric moisture or the plating solution cannot enter base layer 14, so that the resistance to humidity can be improved.

Since base layer 14 is formed of the mixture of diatom earth in 50-90 volumetric % and silicone resin in 50-10 volumetric %, base layer 14 strongly adheres to insulating substrate 11, and yet the yield rate can be improved.

The study of relations among the mixture ratio of the diatom earth in volumetric %, the adhesive strength between base layer 14 and insulating substrate 11, and the presence of cracks on first element 13a is done through the following procedures, and the study results in the following facts: First, the adhesive strength between layer 14 and insulating substrate 11 is tested this way: Paste up a scotch tape tentatively onto base layer 14 having undergone the printing and the curing processes, then peel off the scotch tape and confirm whether or not base layer 14 is peeled off together with the scotch tape from substrate 11. When base layer 14 is not peeled off, it is determined that base layer 14 strongly adheres to substrate 11. On top of that, form first element 13a on base layer 14 by sputtering Ti and Cu, and observe whether or not a crack happens on first element 13a.

The result of the forgoing test is this: When the mixture ratio of diatom earth is not greater than 90 volumetric %, base layer 14 never peels off substrate 11; however, when the mixture ratio exceeds 90 volumetric %, some base layers 14 peel off substrate 11. When the mixture ratio of diatom earth is not less than 50 volumetric %, no cracks occur on first element 13a; however, when the mixture ratio is less than 50 volumetric %, cracks occur on some elements 13a.

Since the adhesive strength between the silicone resin and the alumina forming substrate 11 is strong, a higher mixture ratio of the silicone resin in the mixture of the diatom earth and the silicone resin, both forming base layer 14, allows increasing the adhesive strength between base layer 14 and substrate 11. It means that the higher mixture ratio of the silicone resin can eliminate the step of firing base layer 14 at a temperature over 1000° C., and thus base layer 14 can be bonded to substrate 11 without the firing step.

A higher mixture ratio of the diatom earth in the mixture of the diatom earth and the silicone resin, both forming base layer 14, allows reducing a difference in heat shrinkable properties between element 13a formed by sputtering and base layer 14. First element 13a can be thus free from the cracks due to the difference in the heat shrinkage properties between first element 13a and base layer 14, so that the yield rate can be improved.

Base layer 14 formed of silicone resin, alumina powder, and silica powder allows itself to be stable in shape against the heat produced by the laser beam when trimming grooves 17 are formed by radiating the laser beam, because those materials are excellent both in heat resistant properties and in adhesion properties to insulating substrate 11 which contains alumina. The shape of element 13 can be thus stabilized, so that the blowout characteristics can be also stabilized.

The silicone resin can enter among the particles of the alumina powder and the silica powder, so that base layer 14 can be fixed strongly onto substrate 11, and atmospheric moisture or the plating solution cannot enter base layer 14, so that the resistance to humidity can be improved.

Since base layer 14 strongly adheres to substrate 11, base layer 14 can be bonded to insulating substrate 11 without the step of firing base layer 14 at a temperature over 1000° C., so that the productivity can be improved.

In this embodiment, after first and second trimming grooves 25a, 25b for forming the blowout section are formed, then first-sixth trimming grooves 26a-26f for adjusting resistance value are formed. This procedure allows forming grooves 25a and 25b such that those grooves can satisfy the given blowout characteristics before the resistance value of element 13 is adjusted, so that the blowout characteristics can be stabilized.

Since element 13 is made of metal, the formation of trimming grooves 25a and 25b by radiating a laser beam allows blowout section 18 between grooves 25a and 25b to heighten its resistance value, which is an important factor to the blowout characteristics, than a theoretical value because of the heat produced by the laser beam. However, in this embodiment, trimming grooves 26a-26f for adjusting the resistance value are formed after the formation of grooves 25a and 25b, and the resistance value can be adjusted later than the formation of grooves 25a and 25b. The heat thus dissipates with time, so that the resistance value of blowout section 18 approaches the theoretical value. The blowout characteristics thus can be stabilized.

The resistance value is adjusted with multiple trimming grooves 25a, 25b, and 26a-26f, so that the resistance value can be stabilized.

According to the foregoing method of manufacturing the circuit protecting element in accordance with the embodiment, three trimming grooves for adjusting the resistance value are formed on the left side of first trimming groove 25a which is used for forming the blowout section, and another three trimming grooves for adjusting the resistance value are formed on the right side of second trimming grooves 25b. However, the number of the grooves for adjusting the resistance value is not always three, and they are not always formed on both sides of grooves 25a and 25b in the same quantity. The formation of them on both sides in the same quantity, however, is preferable because this structure can heighten the temperature of blowout section 18.

### INDUSTRIAL APPLICABILITY

The present invention advantageously stabilizes the blowout characteristics, and is useful particularly for a circuit protecting element which blows itself out when an over current flows, thereby protecting a variety of electronic devices.

1. A circuit protecting element comprising:
an insulating substrate;
a pair of surface electrodes formed on both ends of a top face of the insulating substrate;
a base layer disposed between an element and the insulating substrate;
the element covering the base layer and bridging the pair of surface electrodes, and electrically connecting with the pair of surface electrodes; and
an insulating layer covering the element;
wherein the base layer is formed of a mixture of diatom earth and silicone resin.

2. The circuit protecting element of claim 1, wherein the mixture of the diatom earth and the silicone resin contains the diatom earth in a range of 50-90 volumetric %.

3. The circuit protecting element of claim 1, wherein the silicone resin of the base layer is colored.

4. The circuit protecting element of claim 1, wherein the insulating substrate contains alumina, and the base layer is formed of the silicone resin mixed with at least one of alumina powder and silica powder.

5. The circuit protecting element of claim 1, wherein a lateral section of the element is prevented from bulging out from the base layer.

6. The circuit protecting element of claim 1, wherein at least parts of the insulating substrate bulges out from the base layer.

7. The circuit protecting element of claim 1, wherein a blowout section is formed by providing the element with a plurality of trimming grooves.

8. The circuit protecting element of claim 7, wherein metal having a melting point lower than that of the element is provided such that the metal covers at least the blowout section.

9. A method of manufacturing a circuit protecting element, the method comprising the steps of:
forming a pair of surface electrodes on both ends of a top face of an insulating substrate;
forming a base layer made of a mixture of diatom earth and silicone resin on the top face of the insulating substrate such that at least parts of the surface electrodes can be exposed;
forming an element for bridging the pair of surface electrodes on a top face of the base layer, and for electrically connecting with the pair of surface electrodes; and
irradiating the element with a laser beam for forming a pair of trimming grooves which are to be used for forming a blowout section, and a plurality of trimming grooves which are to be used for adjusting a resistance value, such that the element can form meanders; and
forming an insulating layer for covering the element,
wherein the trimming grooves to be used for forming the blowout section are formed before the trimming grooves to be used for adjusting the resistance value are formed.

10. The manufacturing method of claim 9, wherein a space between the pair of trimming grooves to be used for forming the blowout section is set identical to or smaller than a space between the adjacent trimming grooves to be used for adjusting the resistance value and also identical to or smaller than a space between the trimming groove to be used for forming the blowout section and the trimming groove to be used for adjusting the resistance value.

11. The manufacturing method of claim 9, wherein the trimming grooves to be used for forming the blowout section are formed only when a resistance value of the element, on which the trimming grooves to be used for forming the blowout section are not yet formed, falls within a given range.

12. The manufacturing method of claim 9, wherein the trimming grooves to be used for adjusting the resistance value are formed only when a resistance value of the element with the grooves to be used for forming the blowout section formed thereon falls within a given range.

13. The manufacturing method of claim 11, wherein an open-cut groove is formed on the element when a resistance value of the element, on which the trimming grooves for forming the blowout section are not yet formed, falls outside the given range.

14. A method of manufacturing a circuit protecting element, the method comprising the steps of:
forming a pair of surface electrodes formed on both ends of a top face of an insulating substrate;
forming a base layer made of a mixture of diatom earth and silicone resin on the top face of the insulating substrate such that at least parts of the surface electrodes can be exposed; and
forming an element for bridging the pair of surface electrodes on a top face of the base layer, and for electrically connecting with the pair of surface electrodes,
wherein the step of forming the element includes a step of forming a first element by a sputtering method and a step of forming a second element on a top face of the first element by a plating method.

15. A method of manufacturing a circuit protecting element, the method comprising the steps of:
forming a plurality of surface electrodes on a top face of a sheet-like insulating substrate, having a plurality of vertical dividing grooves and horizontal dividing grooves, such that the surface electrodes can stride across the horizontal dividing grooves;
forming a base layer made of a mixture of diatom earth and silicone resin on the top face of the insulating substrate such that at least parts of the surface electrodes can be exposed;
forming a plurality of first elements for bridging a pair of the surface electrodes;
forming a square and frame-like dummy electrode which solidly surrounds a region, where the surface electrodes and the first element are formed, and is formed of a pair of lateral dummy sections and a pair of vertical dummy sections; and
forming a second element on a top face of the first element by an electrical plating method,
wherein the step of forming the dummy electrode connects the pair of lateral dummy sections to the plurality of surface electrodes, and connects a part of the dummy electrode to a power feeder section.

16. The manufacturing method of claim 15, wherein the pair of lateral dummy sections is made non-conductive with the plurality of surface electrodes, and then a resistance value across a pair of the surface electrodes is measured before trimming grooves are formed on the first element and the second element.

17. The manufacturing method of claim 14, wherein the second element is formed by an electroless plating method.

18. The manufacturing method of claim 14, wherein a plurality of the first elements are formed while the insulating substrate is heated from the base layer side.

19. The manufacturing method of claim 14, wherein a stop-off sheet is pasted to a rear face of the insulating substrate before the second element is formed for preventing plating material from attaching to the rear face.

20. The manufacturing method of claim 19, wherein the stop-off sheet is pasted to the rear face by using a temperature of a plating solution.
